(19) United States
(12) Patent Application Publication
(10) Pub. No.: US 2015/0136522 A1
(43) Pub. Date: May 21, 2015

(54) Rescue Method and Rescue Apparatus

(71) Applicants: Uwe Bergmann, Melle (DE); Dirk Bergmann, Spenge (DE)

(72) Inventors: Uwe Bergmann, Melle (DE); Dirk Bergmann, Spenge (DE)

(21) Appl. No.: 14/402,284

(22) PCT Filed: May 14, 2013
(86) PCT No.: PCT/EP2013/059933

§ 371 Date: Nov. 19, 2014

(30) Foreign Application Priority Data
May 21, 2012 (EP) PCTEP2012059409
Sep. 13, 2012 (DE) 10 2012 108 573.0

(51) Int. Cl. A62B 1/20; B63B 23/40; B63B 23/42; A62B 1/14

(52) U.S. Cl. CPC A62B 1/20; A62B 1/14; B63B 23/40; B63B 23/42; B63B 2728/00
USPC 182/70; 182/129

(57) ABSTRACT

A method of rappelling loads (18) from an offshore platform, wherein a rescue raft (30) is lowered from the platform at a rappelling rope (22) until the raft floats on the water, and at least one load (18) is rappelled along the rope into the rescue raft, wherein the rappelling rope is held tensioned by a tension weight (26) that is suspended at a portion of the rappelling rope that passes through the rescue raft (30).

The invention relates to a method and device for rappelling loads, in particular persons, from an offshore platform.

Such rescue devices are needed for example for the servicing personnel of wind power plants. Modern wind power plants with a power capacity of several megawatts may have hub heights of up to 160 m and are installed offshore, among others, for generating electricity. These plants have, at the tip of the tower, a relatively large engine house that may accommodate up to 30 persons during maintenance works. By employing a large number of staff for maintenance and repair, the dead times shall be minimized.

Typically the engine house of the wind power plant can be accessed via a ladder equipped with a climb protection system, or via a person lift inside the tower. In an emergency case, e.g. fire in the engine house or the tower base, it must be assured that all persons that are present in the plant can readily be rescued via an alternative rescue path.

DE 20 2010 002 467 U1 discloses a rescue device that comprises a reel for a rappelling rope, mounted on the platform, a rescue raft attached to the lower end of the rope, and a tensioning device arranged near the lower end of the rappelling rope and adapted to hold the rope under tension even when the raft floats on the water.

The tensioning device assures that the rope is held under a certain tension even in this condition, so that the load that is being rappelled will not collide with the tower or other obstacles but can be grounded in a controlled manner. The load may be attached to a brake unit by means of a harness, and the brake unit will run down along the rope with limited speed. By utilizing a larger number of brake units it is possible to rappel a plurality of persons in rapid succession.

It is an object of the invention to permit the use of a simpler tensioning device.

According to the invention, this object is achieved by a method wherein the rappelling rope is held tensioned by a tension weight that is suspended at a portion of the rappelling rope that passes through the rescue raft.

It is an essential advantage of this method that no complex mechanical tensioning device needs to be installed on the raft, so that space and costs can be saved.

A device that is suitable for carrying out this method is claimed in the independent device claim.

Useful details and further developments of the invention are indicated in the dependent claims.

### An embodiment example will now be explained in conjunction with the drawings, wherein:

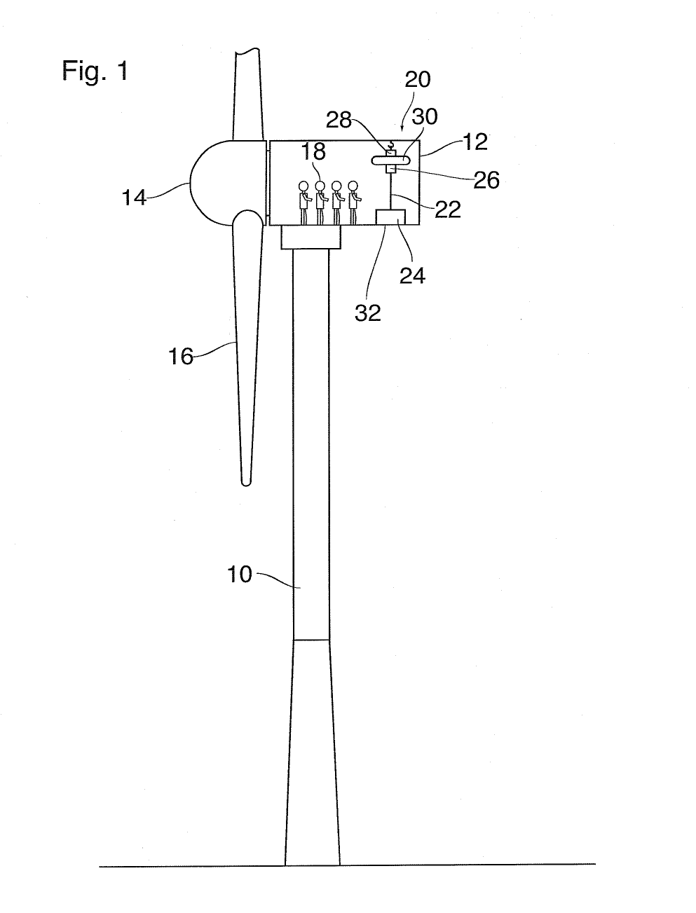

FIG. 1 is a sketch of an offshore wind power plant having a rescue device according to the invention;

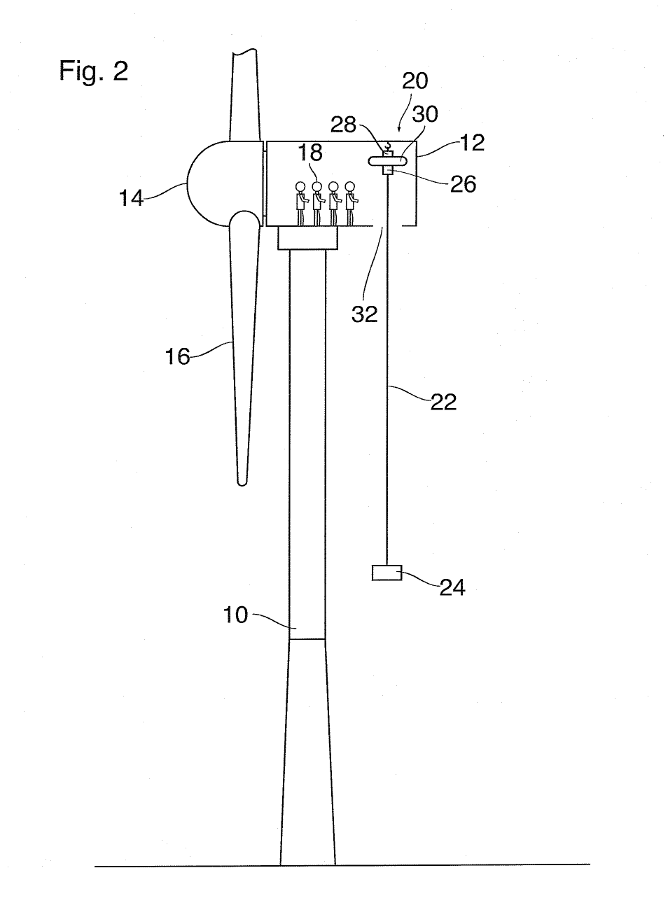

FIGS. 2-5 are sketches analogous to FIG. 1, for illustrating the process flow;

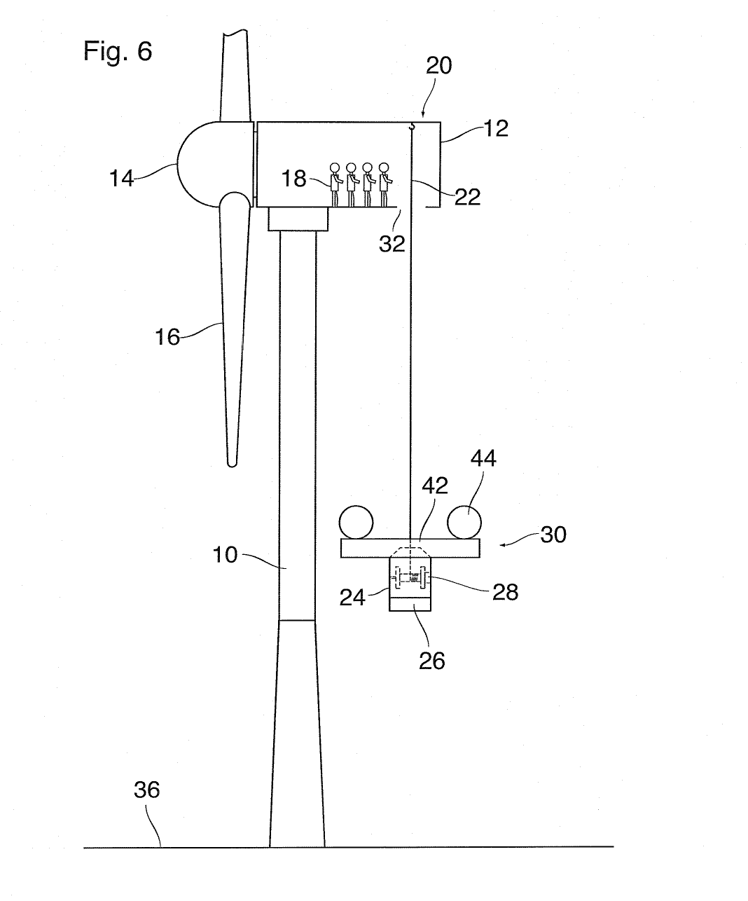

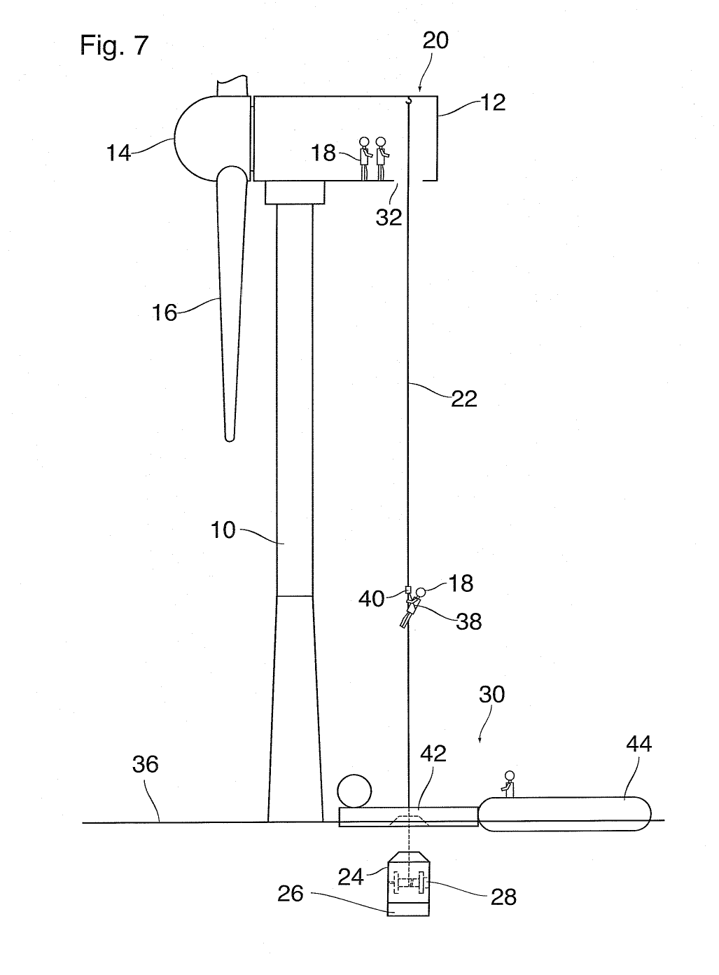

FIGS. 6 and 7 are sketches for a method according to another embodiment; and

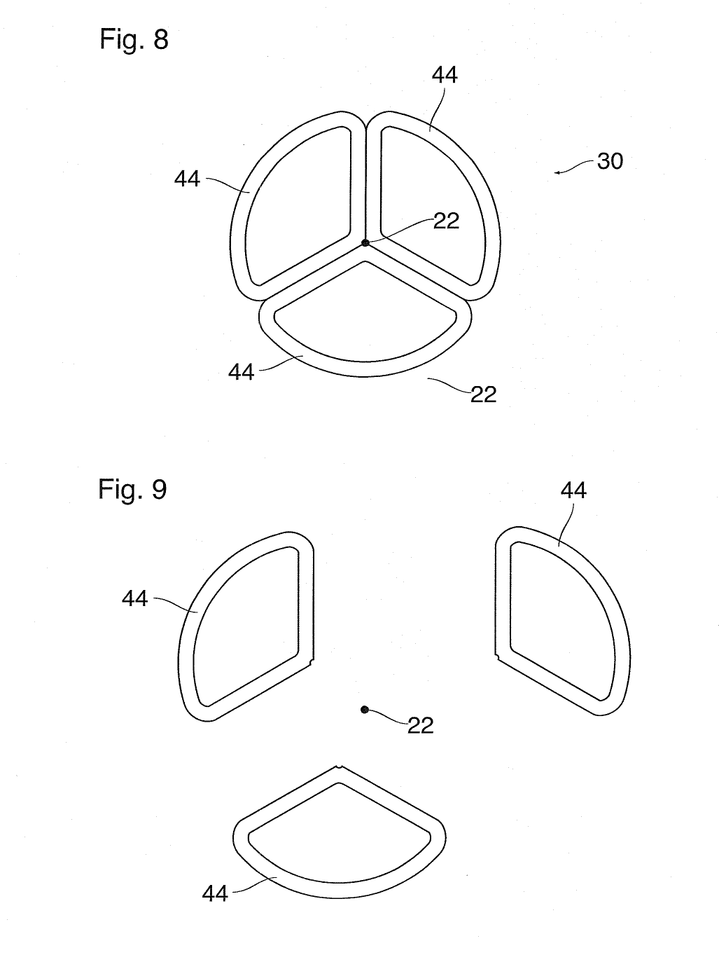

FIGS. 8 and 9 show a plan view of a rescue raft according to another embodiment in two different states of use.

FIG. 1 schematically shows an offshore wind power plant comprising a tower 10, a gondola 12, a hub 14 and rotor blades 16. The gondola 12 accommodates an engine house in which a larger number of persons 18 may be present during maintenance and repair works.

The wind power plant has a rescue device 20 permitting to evacuate the maintenance personnel in an emergency case, e.g. in case of fire in the engine house, in shortest possible time via a separate rescue path (that does not pass through the interior of the tower 10). This rescue device comprises a rappelling rope 22, a rope storage device 24, and a tension weight 26 that is attached to the rope 22 with a brake unit 28. In the example shown, a rubber boat or rescue raft 30 is arranged, at first in a collapsed condition, between the tension weight 26 and the brake unit 28.

For reasons of fire safety, the rappelling rope 22 should preferably be a steel rope. One end of the rope 22 is safely attached to the gondola 12, e.g. at the roof of the engine house. The other end of the rope is at first accommodated in the storage device 24 that is also stored inside the gondola 12. The storage device may for example be a drum or simply a box that accommodates the rope in a flaked or coiled state. If the storage device accommodates a rope coil, this is preferably coiled with a certain twist for improving the unwinding properties. In the simplest case, the storage device may be a belt that holds the rope in a coiled state or flaked as a packet and that is removed or cut-through when the rescue device is to be used. The tension weight 26 and the rescue raft 30 are held by means of a brake unit 28 at a section of the rope 22 between the top end and the section accommodated in the storage device 24.

The rescue device 20 may be installed permanently in the gondola 12. It is possible, however, to retrofit an existing wind power plant with the rescue device 20. Likewise is it possible that the servicing personnel brings the rescue device 20 and installs it in the gondola 12 when the maintenance works are to start.

In the example shown the storage device 24 is formed by a box that is detachably held in a porthole 32 formed in the floor of the gondola 12. When the persons 18 are to be evacuated, the storage device 24 is detached from its holder and dropped so that it clears the porthole 32 as shown in FIG. 2. While the top end of the rope 22 remains attached to the gondola 12, the storage device 24 moves down due to its own weight and the weight of the rope accommodated therein, the rope 32 being progressively drawn out of the storage device 24. The storage device may be designed such that the withdrawal of the rope is braked to some extent and consequently the fall velocity of the rope is controlled.

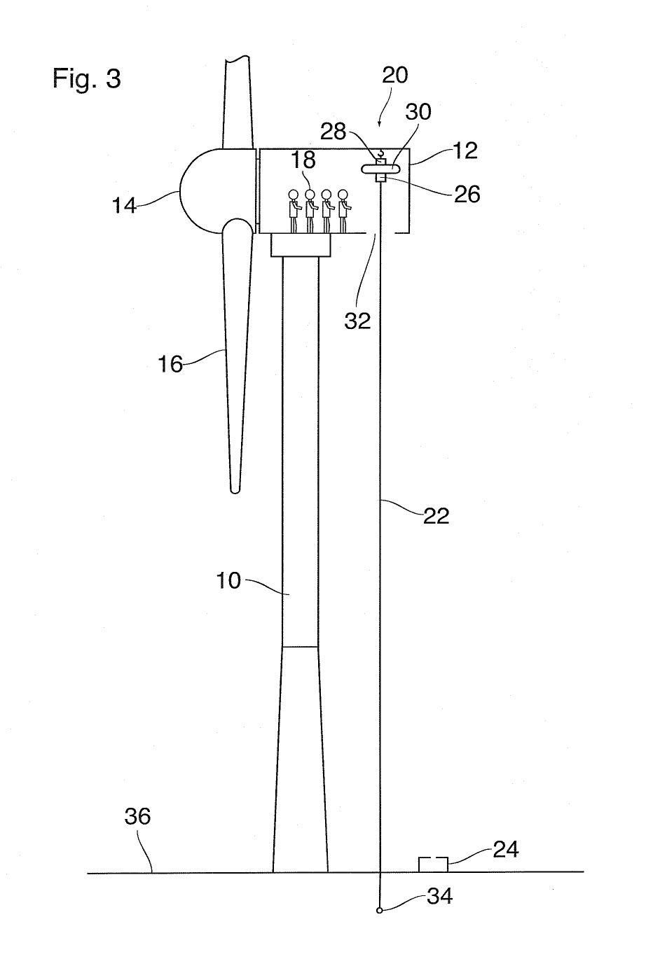

In FIG. 3 the rappelling rope 22 has been withdrawn completely from the storage device 24 and depends freely from the gondola 12. The length of the rope 22 is selected such that its lower end, to which a stop 34 is attached, is somewhat below the water surface 36. The storage device 24 has fallen off and floats on the water surface.

In this state, a lock that has fixed the brake unit to the rope 22, e.g. by means of a clamping mechanism, is detached, so that the brake unit 28 with the tension weight 26 and the rescue raft 30 attached thereto starts to move down along the rope 22. The brake unit 28 includes a brake, e.g. a centrifugal brake, that limits the rappelling speed of the tension weight 26. The brake unit 28 may be clamped detachably to the rope 22 so that it is possible, in a modified embodiment, that the brake unit and the tension weight 26 are attached to the rope 22 only at the time when the rope has been dropped and withdrawn from the storage device.

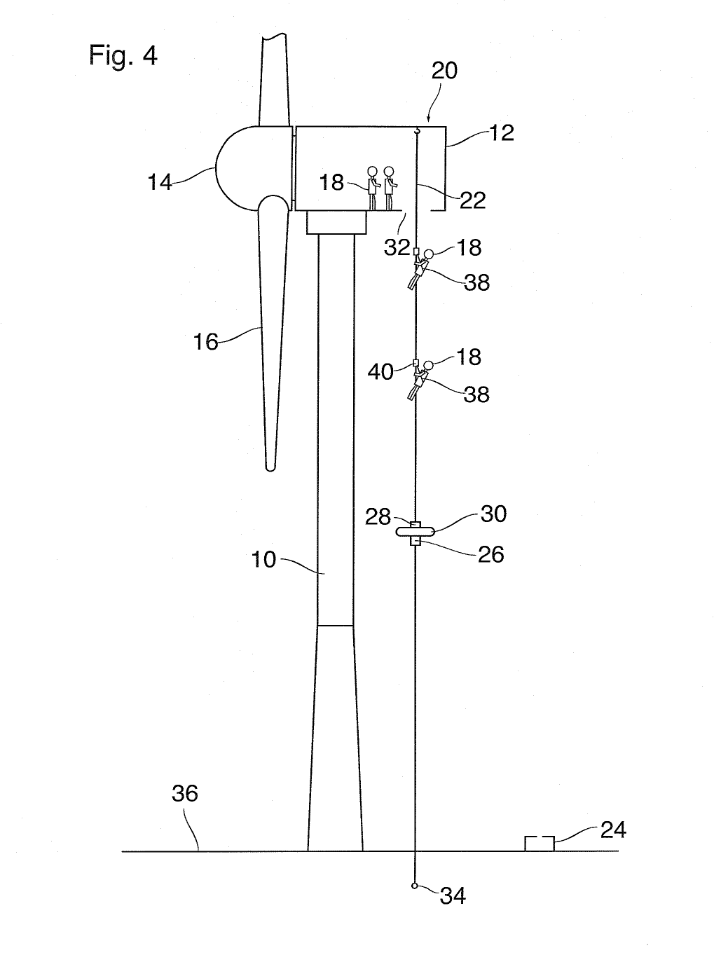

FIG. 4 shows the rescue device in a state in which the tension weight 26 moves down along the rappelling rope 22 with a speed that is limited by the brake unit 28. The part of the rope 22 that is still below the tension weight 26 is not subject to any substantial tension forces. In contrast, the part of the rope above the tension weight 26 is tensioned by the tension weight 26 and is thereby stabilized in its position such that it extends vertically downward from the porthole 32.

In this condition, it is possible to start already with evacuating the persons 18, even though the tension weight 26 had not yet reached the lower end of the rope. To that end, each person 18 puts on a harness 38 that is connected to a brake unit 40. The brake unit 40 may have a design similar to that of the brake unit 28 but may be designed for a lower weight. For example, the brake unit 40 includes clamping rollers (not shown) with which it is clamped to the rope 22 so that it can roll down along the rope in a controlled manner. Further, the brake unit 40 includes a brake, e.g. a centrifugal brake, that limits the speed with which the brake unit moves down along the rope 22 to a maximum value of 2 m/s for example. This maximum value should be slightly lower than the maximum speed to which the brake unit 28 for the tension weight 26 has been calibrated. In this way, the persons 18 can be rappelled one after another via the rope 22 without running onto the tension weight 26. In FIG. 4, two persons 18 are being rappelled already along the rope 22. The remaining persons may follow in suitable intervals.

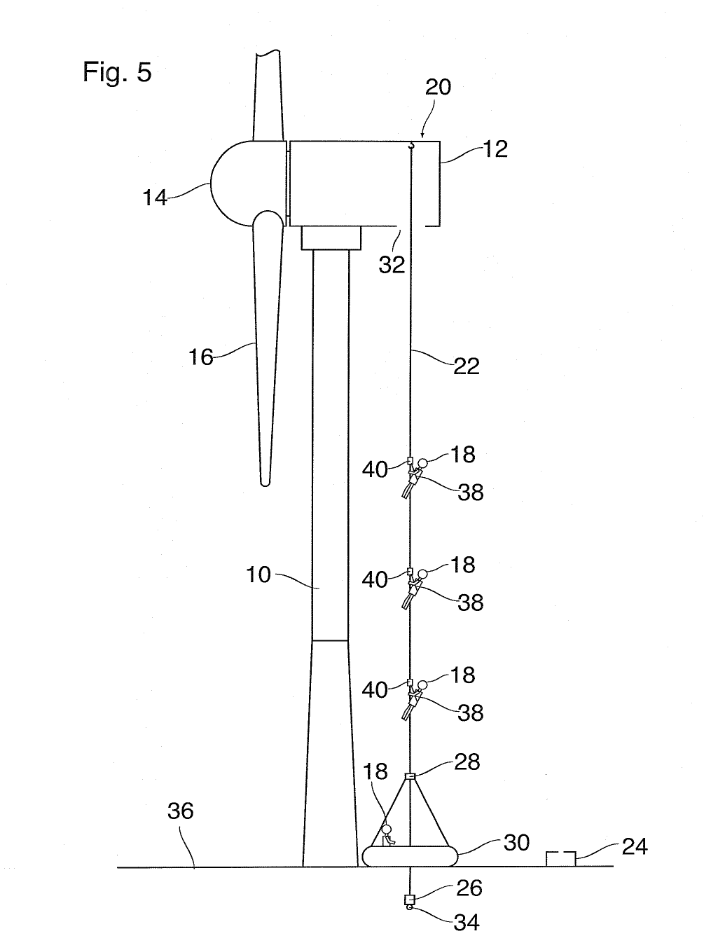

In FIG. 5 the tension weight 26 has reached its lower end position on the rappelling rope 22. The tension weight 26 is stopped in this end position by the stop 34. The impact of the brake unit 28 on the stop 34 triggers the automatic deployment and inflation of the rescue raft 30. The rescue raft floats on the water but is still connected to the rope 22 by the brake unit 28. For example, the rope passes through a valve or a water-tight feedthrough in the bottom of the rescue raft 30 towards the tension weight 26. This assures that, in this condition, the tension weight 26 still exerts a tensioning force on the rope 22 and holds the same in a tensioned state so that the following persons 18 may be rappelled safely until they have reached the rescue raft.

When all persons have been rappelled into the rescue raft 30, the brake unit 28 may be detached from the rope and the tension weight may be dropped in order to free the rescue raft from the rappelling rope. A suitable trigger mechanism may be provided for dropping the tension weight, or the tension rope may be cut-through above the floor of the rescue raft.

The embodiment example that has been described above may be modified in various ways.

For example, the rope storage device 24 may be connected non-detachably to the lower end of the rope 22. In this case, the storage device may also fulfill the function of the stop 34.

On the other hand, it is possible that the storage device 24 is installed permanently in the gondola 12 and the rope 22 is simply dropped out of the storage device when the evacuation begins.

FIG. 6 shows a modified embodiment example in which the rescue raft 30 is formed by a float 42 that carries two rescue modules 44, e.g. inflatable rubber boats, which are adapted to be uncoupled from the float and have been shown in FIG. 6 in the non-inflated state. The rappelling rope passes centrally through the float 42, and during the process of rapelling, the float 42 is supported on the storage device 24 via a centering cone. In this example, the storage device includes a drum from which the rope is withdrawn and a rotary speed of which is limited by the braking device 28. The tension weight 26 is formed by the weight of the storage device or, more particularly by a heavier bottom plate of this storage device.

Also in this embodiment, it is possible to begin with rappelling the persons 18 in the condition shown in FIG. 6, i.e. while the rescue raft 30 is still being lower. However, when there are strong dusts of wind, it is also possible to wait until the rescue raft 30 has been lowered completely and floats on the water, as shown in FIG. 7.

In the condition shown in FIG. 7, the storage device 24 and the tension weight 26 are immersed in the water, so that they hold the rappelling rope 22 under tension. If the rappelling rope should start to swing, the flow resistance of the storage device 24 will dampen the oscillations. The float 42 floats on the water at a certain distance above the storage device 24 and serves as landing place for the persons that rappel along the rope. In FIG. 7, one of the rescue modules 44 has already been inflated into the boat configuration so that the persons may change from the float 42 into the rescue module 44.

As soon as a rescue module 44 is occupied with persons that have been rescued, it may be uncoupled from the float 42 in order to take the persons to a salvage vessel or to the coast.

At the end of the rescue operation, only the rappelling rope 22 with the float 42 and the unit formed by the storage device 24 and the tension weight 26 will remain at the wind power plant. When the storage device 24 and the tension weight 26 are recovered, the attachment of the rappelling rope 22 at the gondola 12 may be released by means of a remote control mechanism so that the rope will drop down and the rescue device is separated completely from the wind power plant without requiring any persons to mount to the gondola.

FIG. 8 shows a schematic plan view of a rescue raft 30 according to another embodiment example. In this example, the rescue raft 30 is formed by three rescue modules 44 that are configured as rubber boats each of which has the shape of a 120° sector of a circle in plan view so that the modules complement each other to form a full circle, with the rappelling rope 22 passing through between the rescue modules at the center of the circle. During the rescue operation the rescue modules 44 are coupled to one another so that they may not drift away from the rappelling rope 22. When the rescue operation is accomplished and all persons that have been saved are in the rescue modules 44, the latter are detached from one another, so that they may withdraw also from the rappelling rope 22, as has been shown in FIG. 9.

1. A method of rappelling loads from an offshore platform, comprising the steps of:
lowering a rescue raft from the platform at a rappelling rope until the raft floats on a body of water,
rappelling at least one load along the rope into the rescue raft, and
tensioning the rappelling rope by a tension weight that is suspended at a portion of the rappelling rope that passes through the rescue raft.

2. The method according to claim 1, wherein the tension weight is connected to the rappelling rope via a speed-limiting braking device and further comprising the step of moving the tension weight down along the rope into a lower end position with limited speed.

3. The method according to claim 2, wherein the step of rappelling includes the steps of:
rappelling the rescue raft together with the tension weight and
supporting the rescue raft on the tension weight during rappelling.

4. The method according to claim 2, wherein the step of rappelling includes starting rappelling of said at least one load before the tension weight has reached the lower end position.

5. The method according to claim 1, wherein the rappelling rope is attached to the platform at one end thereof, and further including the step of withdrawing a major part of the rappelling rope from a rope storage device while the rope is lowered from the platform.

6. The method according to claim 5, further including the step of dropping the storage device from the platform in order to lower the rope.

7. A device for rappelling loads from an offshore platform, comprising:
a rappelling rope,
a rescue raft to be rappelled at the rope, wherein the rappelling rope passes through the rescue raft, and
a tension weight suspended at the rappelling rope below the rescue raft.

8. The device according to claim 7
further including a braking device, and wherein the tension weight is connected to the rappelling rope via the braking device and is adapted to be moved down along the rope into a lower end position with limited speed.

9. The device according to claim 7, further comprising a plurality of brake units that are adapted to be detachably clamped to the rappelling rope and to which a respective load can be attached and which are adapted to move along the rappelling rope with a speed that is limited by a brake action.

10. The device according to claim 7, wherein the rescue raft has at least one rescue module that is adapted to be uncoupled from the rappelling rope that is held under tension by the tension weight.
